(19) United States
(12) Patent Application Publication
(10) Pub. No.: US 2024/0119288 A1
(43) Pub. Date: Apr. 11, 2024

(54) METHOD FOR CONVERTING NEURAL NETWORK, ELECTRONIC DEVICE AND STORAGE MEDIUM

(71) Applicant: AAC Technologies Pte. Ltd., Singapore (SG)

(72) Inventor: Caglar Aytekin, Tampere (FI)

(21) Appl. No.: 17/962,559

(22) Filed: Oct. 10, 2022

(51) Int. Cl. G06N 3/08; G06N 3/04

(52) U.S. Cl. CPC G06N 3/082; G06N 3/0427

(57) ABSTRACT

A method for converting neural network, applied to a terminal device, including: initializing a decision tree, and setting a root of the decision tree; and branching leafs from the root of the decision tree based on effective filters of the neutral network as a decision rule, until all effective filters of the neutral network are covered by the decision tree. The neutral network is a piece-wise linearly activated neutral network. In this method, the neutral network is converted as decision trees and is explained based on the decision trees, so as to solve the black-box problem of the neutral network.

### TECHNICAL FIELD

The present disclosure relates to the field of computer technologies and, in particular, to a method for converting neural network, electronic device and storage medium.

### BACKGROUND

In the field of computer technologies, the application of neutral network is more and more widely applied. However, the black-box nature of their predictions prevent their wider and more reliable adoption of the neutral network in many industries, such as health and security. This fact led researchers to investigate ways to explain neural network decisions, which is called as explainable artificial intelligence (XAI). The efforts in explaining neural network decisions can be categorized into saliency maps and linking neural networks to interpretable methods.

Saliency maps are ways of highlighting areas on the input, of which a neural network make use of while prediction. In the related art, the gradient of the neural network output with respect to the input is taken in order to visualize an input-specific linearization of the entire network. The saliency maps obtained via this method are often noisy and prevent a clear understanding of the decisions made.

Another track of the related art make use of the derivative of a neural network output with respect to an activation, usually the one right before fully connected layers. This saliency maps obtained by this track are clearer in the sense of highlighting areas related to the predicted class. Although useful for purposes such as checking whether the support area for decisions are sound, these methods still lack a detailed logical reasoning of why such decision is made.

It is therefore necessary to provide a method for explaining decisions of the neutral network.

### SUMMARY

In order to solve the technical problems in the related art, embodiments of the present disclosure provide a method for converting neutral network, an electronic device, and a non-transitory storage medium.

In a first aspect, the present disclosure provides a method for converting neural network, applied to a terminal device, including: initializing a decision tree, and setting a root of the decision tree; and branching leafs from the root of the decision tree based on effective filters of the neutral network as a decision rule, until all effective filters of the neutral network are covered by the decision tree. The neutral network is a piece-wise linearly activated neutral network.

As an improvement, the branching leafs from the root of the decision tree includes: starting from nodes branched from the root of the decision tree, further branching the nodes into leaf branches each corresponding to an effective filter. An order of the effective filters is based on an order of the effective filters in a same layer of the neutral network and orders in different layers of the neutral network.

As an improvement, for a fully connected layer, an effective matrix is adopted as the decision rule.

As an improvement, for a skip connection layer, a residual effective matrix is adopted as the decision rule.

As an improvement, for a normalization layer, the normalization layer is embedded in a linear layer before or after for pre-activation normalization or post-activation normalization, respectively.

As an improvement, for a convolution layer, an effective convolution is adopted as the decision rule.

As an improvement, the method further includes lossless pruning the decision tree based on violating rules and/or redundant rules of the decision tree.

As an improvement, the method further includes lossless pruning the decision tree based on categories realized during training of the neural network.

In a second aspect, the present disclosure provides a method for computing neutral network, including: obtaining data to be computed; obtaining a first neutral network for computing the data to be computed; converting the first neutral network into a first decision tree based on the methods in the first aspect as above; and computing the data to be computed using the first decision tree, to obtain the computing results.

In a third aspect, the present disclosure provides an electronic device, including a memory storing executable instructions; and at least one processor coupled to the memory, when executing the executable instructions, the at least one processor is configured to perform the methods according to the first aspect.

In a fourth aspect, the present disclosure provides an electronic device, including a memory storing executable instructions; and at least one processor coupled to the memory, when executing the executable instructions, the at least one processor is configured to perform the methods according to the second aspect.

In a fifth aspect, the present disclosure provides a non-transitory storage medium storing computer executable instructions, when the computer executable instructions are executed on a computer, the computer is triggered to perform the methods according to the first aspect.

In a sixth aspect, the present disclosure provides a non-transitory storage medium storing computer executable instructions, when the computer executable instructions are executed on a computer, the computer is triggered to perform the methods according to the second aspect.

Compared with the related art, the above technical solutions can at least bring the following beneficial effects:

The neutral network is converted as decision trees and is explained based on the decision trees, so as to solve the black-box problem of the neutral network.

Moreover, the decision tree equivalent of the network may effectively reduce the computational cost of the neural network at the expense of increased memory.

### BRIEF DESCRIPTION OF DRAWINGS

FIG. 1 is a flow diagram of a method according to an embodiment of the present disclosure.

FIG. 2 is a schematic diagram of a decision tree according to an embodiment of the present disclosure.

FIG. 3 is a schematic diagram of a decision tree according to another embodiment of the present disclosure.

FIG. 4 is a schematic diagram of a decision tree according to another embodiment of the present disclosure.

FIG. 5 is a schematic diagram of model response according to an embodiment of the present disclosure.

FIG. 6 is a schematic diagram of a decision tree according to another embodiment of the present disclosure.

FIG. 7 is a schematic diagram of a decision tree according to another embodiment of the present disclosure.

FIG. 8 is a schematic diagram of a process of computing a neutral network according to an embodiment of the present disclosure.

FIG. 9 is a block diagram of an electronic device according to an embodiment of the present disclosure.

### DESCRIPTION OF EMBODIMENTS

Embodiments described below with reference to the accompanying drawings are exemplary and are only configured to explain the present disclosure, but not to be construed as limitations to the present disclosure.

The terms used in the present disclosure are only intended for explanation, rather than limitations to the present disclosure.

In regard to the problem of the related art of how to explain decision of the neutral network, embodiments of the present disclosure provides a method for converting neutral network. In this method, the neutral network having piece-wise linear activation functions is converted as an equivalent decision tree. The induced tree output is exactly the same with neural network, it doesn't limit or require altering of the neural architecture in any way. Thus, it is possible to explain every decision made within the neural network.

In an embodiment, during the process of converting neutral network into decision tree, an effective filter of each layer of the neutral network is regarded as the decision rule of a corresponding layer of the decision tree.

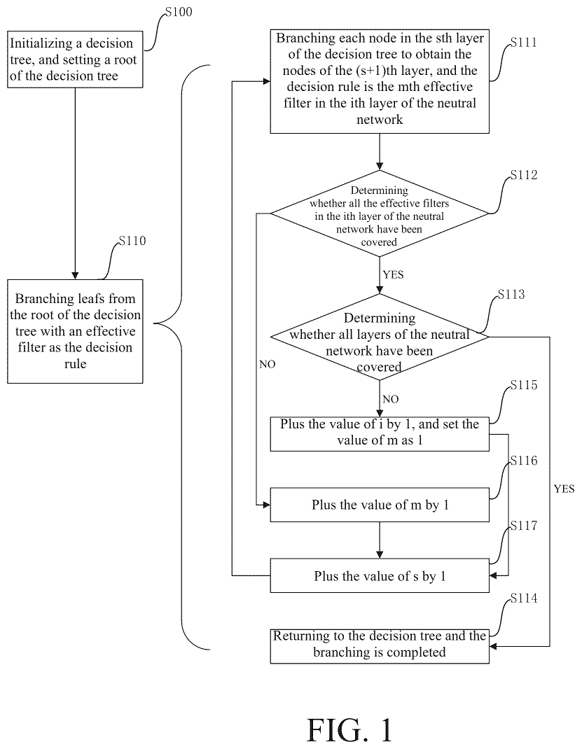

FIG. 1 is a flow diagram of a method according to an embodiment of the present disclosure. An electronic device executes the process shown in FIG. 1 to implement converting the piece-wise linear activated neutral network as a decision tree.

S100, initializing a decision tree, and setting a root of the decision tree.

S110, branching leafs from the root of the decision tree with an effective filter as the decision rule.

In S110, starting from nodes branched from the root of the decision tree, the nodes are each further branched to leafs and each leaf corresponds to an effective filter. The order of the effective filters is based on the order of the filters in a same layer and also orders in different layers.

For example, in a first branch from the root of the decision tree (e.g., into k nodes), the decision rule is a first effective filter in a first layer of the neutral network. Specifically, the k corresponds to the number of piece-wise linear regions in the activation function used.

Then, each node (of the k nodes) obtained from the first branching is subjected to a second branching, and the decision rule is a second effective filter in a first layer of the neutral network.

Continue the branching until all the effective filters in the first layer of the neutral network are covered.

Then the branching continues to the second layer of the neutral network, and the decision rule is the first effective filter in the second layer.

Repeating the branching until all the effective filters in all the layers of the neutral network are covered.

In an embodiment, S110 includes the following steps.

S111, branching each node in the sth layer of the decision tree to obtain the nodes of the (s+1)th layer, and the decision rule is the mth effective filter in the ith layer of the neutral network.

In S111, an initial value of each of s, i and m is 1, and the node of the first layer of the decision tree is the root of the decision tree.

S112, determining whether all the effective filters in the ith layer of the neutral network have been covered.

If all the effective filters in the ith layer of the neutral network have been covered, executing S113.

S113, determining whether all layers of the neutral network have been covered.

If all layers of the neutral network have been covered, executing S114.

S114, returning to the decision tree and the branching is completed.

If layers of the neutral network have not been fully covered, executing S115.

S115, plus the value of i by 1, and set the value of m as 1.

If the ith layer of the neutral network is not fully covered, executing S116.

S116, plus the value of m by 1.

After S115 or S116, executing S117.

S117, plus the value of s by 1.

After S117, return to S111.

The process of converting the neutral network into equivalent decision tree is described as below with respect to neutral networks having different piece-wise linear activated structures.

(I) Fully Connected Networks (Fully Connected Layers)

Let Wᵢ be the weight matrix of a network's ith layer. Let σ be any piece-wise linear activation function, and x₀ be the input to the neural network. Then, the output and an intermediate feature of a feed-forward neural network can be represented as in Equation 1.

NN(x₀)=Wₙ₋₁^{T}σ(Wₙ₋₂^{T}σ( . . . W₁^{T}σ(W₀^{T}x₀)))

xᵢ=σ(Wᵢ₋₁^{T}σ( . . . W₁^{T}σ(W₀^{T}x₀))) (1).

Note that in Equation 1, any final activation (e.g. softmax) is omitted and the bias term is ignored as it can be simply included by concatenating a 1 value to each xᵢ. The activation function σ acts as an element-wise scalar multiplication, hence the following can be written into Equation 1.

Wᵢ^{T}σ(Wᵢ₋₁^{T}xᵢ₋₁)=Wᵢ^{T}(aᵢ₋₁⊗(Wᵢ₋₁^{T}xᵢ₋₁))) (2).

In Equation 2 above:
aᵢ₋₁ is a vector indicating the slopes of activations in the corresponding linear regions where Wᵢ₋₁^{T}xᵢ₋₁ fall into, and
⊗ denotes element-wise multiplication.

Note that, aᵢ₋₁ can directly be interpreted as a categorization result since it includes indicators (slopes) of linear regions in activation function.

The Equation 2 can be re-organized as follows.

Wᵢ₋₁^{T}σ(Wᵢ₋₁^{T}xᵢ₋₁)=(Wᵢ⊗aᵢ₋₁)Wᵢ₋₁^{T}xᵢ₋₁ (3).

In Equation 3, ⊗ is used as a column-wise element-wise multiplication on Wᵢ. This corresponds to element-wise multiplication by a matrix obtained via by repeating aᵢ₋₁ column-vector to match the size of Wᵢ.

Using Equation 3, Equation 1 can be rewritten as follows.

NN(x₀)=(Wₙ₋₁⊗aₙ₋₂)^{T}(Wₙ₋₂⊗aₙ₋₃)^{T} . . . (W₁⊗a₀)^{T}W₀^{T}x₀ (4).

From Equation 4, one can define an effective weight matrix Ŵᵢ^{T} of a layer i to be applied directly on input x₀ as follows:

_{c}_{_{i−1}}Ŵᵢ^{T}=(Wᵢ⊗aᵢ₋₁⁾T . . . (W₁⊗a₀)^{T}W₀^{T}

_{c}_{_{i−1}}Ŵᵢ^{T}x₀=Wᵢ^{T}xᵢ (5).

In Equation 5, the categorization layer until layer i is defined as follows: cᵢ₋₁=a₀∥a₁∥ . . . aᵢ₋₁, where ∥ is the concatenation operator.

From Equation 5 it is observed that, the effective matrix of layer i is only dependent on the categorization vectors from previous layers. This indicates that the computing of filters that will make the next categorization depends solely on previous categorizations.

This directly shows that a fully connected neural network can be represented as a single decision tree, where effective matrices acts as categorization rules. In each layer i, response of effective matrix _{c}_{_{i−1}}Ŵᵢ^{T} is categorized into aᵢ vector, and based on this categorization result, next layer's effective matrix _{c}_{_{i−1}}Ŵᵢ₊₁^{T} is determined.

A layer i is thus represented as k^{mi}-way categorization, where mᵢ is the number filters, in each layer i and k is the total number of linear regions, in an activation. This categorization in a layer i can thus be represented by a tree of depth mᵢ, where a node in any depth is branched into k categorizations.

In view of the above, according to the present disclosure, in the process of converting neutral network into decision tree, the effective matrix of each layer in the fully connected neutral network is used as the effective filter of S110, and the effective matrix is used as the decision rule (categorization rule) in corresponding layers of the decision tree. Specifically, Equation 5 is used to compute the effective matrix of the fully connected neutral network, so as to determine the decision rule of the decision tree.

In an embodiment, rectified linear unit (ReLU) is adopted as the activation function. For a ReLU neutral network, the following algorithm flow is adopted for converting fully connected neutral network into decision tree.

Algorithm 1:

| | |
|---|---|
| 1 | Ŵ = W₀ |
| 2 | for i=0 to n − 2 do |
| 3 | a=[ ] |
| 4 | for j =0 to mᵢ − 1 do |
| 5 | if Ŵᵢⱼ^{T} x₀ > 0 then |
| 6 | a.append(1) |
| 7 | else |
| 8 | a.append(0) |
| 9 | end |
| 10 | end |
| 11 | Ŵ = Wᵢ₊₁ ⊗ a |
| 12 | end |
| 13 | return Ŵ^{T} x₀ |

In Algorithm 1, a∈0,1.

Lines 4 to 8 of Algorithm 1 correspond to a node in the decision tree, a decision of YES/NO is made in that node.

(II) Skip Connections

Taking the residual neural network of the following type as an example:

ᵣx₀=W₀^{T}x₀

ᵣxᵢ=ᵣxᵢ₋₁+Wᵢ^{T}σ(ᵣxᵢ₋₁) (6).

Using Equation 6, via a similar analysis in Equations 1-5, one can rewrite ᵣxᵢ as follows.

ᵣxᵢ=Ŵᵢ^{T}ᵣxᵢ₋₁

ₐ_{_{i−1}}Ŵᵢ^{T}=I+(Wᵢ⊗aᵢ₋₁)^{T} (7).

Using Ŵᵢ^{T} in Equation 7, one can define effective matrices for residual neural

networks as follows.

ᵣxᵢ=ᵣŴᵢ^{T}x₀

_{c}_{_{i−1}}Ŵᵢ^{T}=ₐ_{_{i−1}}Ŵᵢ^{T}ₐ_{_{i−2}}Ŵᵢ₋₁^{T} . . . ₐ_{₀}Ŵ₁^{T}W₀^{T} (8).

In Equation 8, c is defined as the concatenated categorization results from previous layers. It can be observed from Equation 8 that, for layer i, the residual effective matrix ᵣŴᵢ^{T} is defined based on categorizations from the previous activations, and ᵣŴᵢ^{T} is used as the effective filter in S110.

(III) Normalization Layers

A separate analysis is not needed for any normalization layer, as popular

normalization layers are linear and after training, they can be embedded into the linear layer that it comes after or before, in pre-activation or post-activation normalizations respectively.

(IV) Convolutional Neutral Networks (Convolutional Layers)

Let Kᵢ: C₁₊₁×Cᵢ×Mᵢ×Nᵢ be the convolution kernel for layer i, applying on an input Fᵢ: Cᵢ×Hᵢ×Wᵢ. One can write the output of a convolutional neural network CNN (F₀), and an intermediate feature Fᵢ as follows.

CNN(F₀)=Kₙ₋₁*σ(Kₙ₋₂*σ( . . . σ(K₀F₀)))

Fᵢ=σ(Kᵢ₋₁*σ( . . . σ(K₀F₀))) (9).

Similar to the fully connected network analysis in Equations 1-5, one can write the following, due to element-wise scalar multiplication nature of the activation function.

Kᵢ*σ(Kᵢ₋₁*Fᵢ₋₁)=(Kᵢ⊗aᵢ₋₁)*(Kᵢ₋₁*Fᵢ₋₁) (10).

In Equation 10, aᵢ₋₁ is of same spatial size as Kᵢ and consists of the slopes of activation function in corresponding regions in the previous feature Fᵢ₋₁.

Note that the above only holds for a specific spatial region, and there exists a separate aᵢ₋₁ for each spatial region that the convolution Kᵢ₋₁ is applied to. For example, if Kᵢ₋₁ is a 3×3 kernel, there exists a separate aᵢ₋₁ for all 3×3 regions that the convolution is applied to.

An effective convolution _{c}_{_{i−1}}\hat{K}ᵢ can be written as follows.

_{c}_{_{i−1}}\hat{K}ᵢ=(Kᵢ⊗aᵢ₋₁)* . . . *(K₁⊗a₀)*K₀

_{c}_{_{i−1}}\hat{K}ᵢx₀=Kᵢxᵢ (11).

The effective convolution _{c}_{_{i−1}}\hat{K}ᵢ is used as the effective filter in S110.

Note that in Equation 11, _{c}_{_{i−1}}\hat{K}ᵢ contains specific effective convolutions per region, where a region is defined according to the receptive field of layer i.

c is defined as the concatenated categorization results of all relevant regions from previous layers. One can observe from 11 that effective convolutions are only dependent on categorizations coming from activations, which enables the tree equivalence—similar to the analysis for fully connected network. A difference from fully connected layer case is that many decisions are made on partial input regions rather than entire x₀.

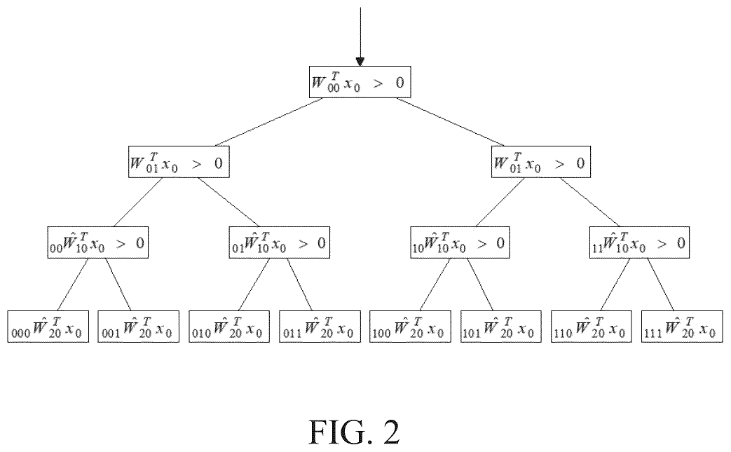

FIG. 2 is a schematic diagram of a decision tree according to an embodiment of the present disclosure.

Referring to the process shown in FIG. 1 and the decision tree shown in FIG. 2, the depth (total layer) of the equivalent decision tree converted from the neutral network is:

d=Σᵢ₌₀ⁿ⁻²mᵢ (12).

The total number of categories in last branch is 2^{d}. At first glance, the number of categories seem huge. For example, if first layer of a neural network contains 64 filters, there would exist at least 2⁶⁴ branches in a tree, which is already intractable.

In order the control the total number of categories of the decision tree, in an embodiment, the equivalent decision tree is pruned lossless based on violating and redundant rules of the decision tree.

For example, we fit a neural network to: y=x² equation. The neural network has 3 dense layers with 2 filters each, except for last layer which has 1 filter. The network uses leaky-ReLU activations after fully connected layers, except for last layer which has no post-activation.

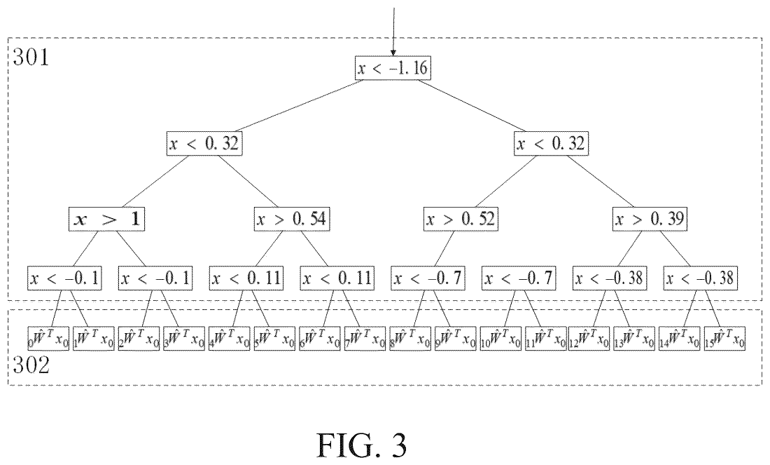

FIG. 3 is a schematic diagram of a decision tree according to another embodiment of the present disclosure. In this embodiment, the decision tree obtained from y=x² regression neutral network is as shown in FIG. 3.

In the tree, every black rectangle box in 301 indicates a rule, left child from the box means the rule does not hold, and the right child means the rule holds.

For better visualization, the rules are obtained via converting W^{T}x+β>0 to direct inequalities acting on x. This can be done for the particular regression y=x₂, since x is a scalar. In every leaf, the network applies a linear function indicated by a rectangle in 302 based on the decisions so far.

As shown in FIG. 3, the tree representation of a neural network in this example seems large due to the 2^{Σ}^{ᵢ₌₀}^{^{n−2}}^{m}^{ᵢ}=2⁴≤16 categorizations.

However, a lot of the rules in the decision tree is redundant, and hence some paths in the decision tree becomes invalid.

An example to redundant rule is checking x<0.32 after x<−1.16 rule holds. This directly creates the invalid right child for this node. Hence, the tree can be cleaned via removing the right child in this case, and merging the categorization rule to the stricter one: x<−1.16 in the particular case.

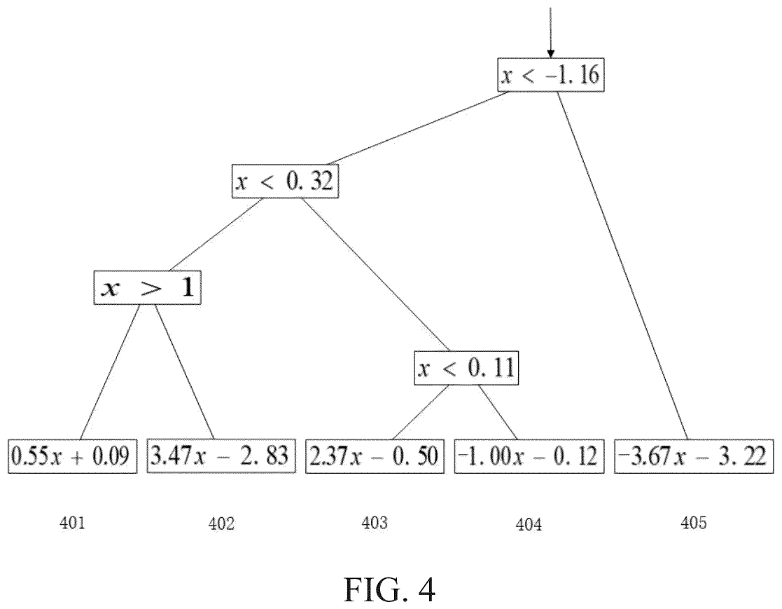

FIG. 4 is a schematic diagram of a decision tree according to another embodiment of the present disclosure.

Through pruning the decision tree of FIG. 3, the decision tree in FIG. 4 is obtained. The decision tree includes 5 categories (401-405) rather than 16 categories.

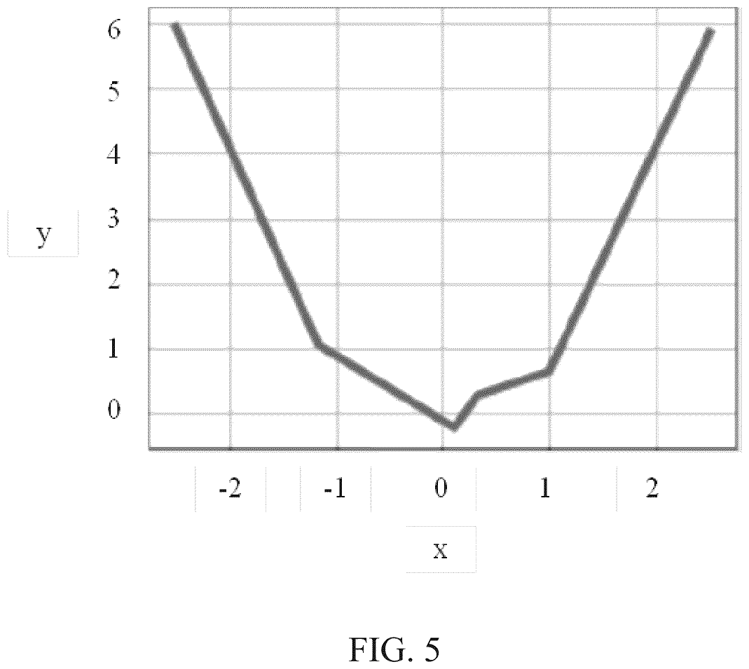

FIG. 5 is a schematic diagram of model response according to an embodiment of the present disclosure. The model response of the decision tree in FIG. 4 is shown in FIG. 5.

Based on the decision tree of FIG. 4, The interpretation of the neural network is thus straightforward: for each region whose boundaries are determined via the decision tree representation, the network approximates the non-linear y=x² equation by a linear equation.

One can clearly interpret and moreover make deduction from the decision tree, some of which are as follows. The neural network is unable to grasp the symmetrical nature of the regression problem which is evident from the fact that the decision boundaries are asymmetrical. The region in below −1.16 and above 1 is unbounded and thus neural decisions lose accuracy as x goes beyond these boundaries.

In addition, since the number of categories may be more than the training data, and not all the categories will be implemented during training of the neutral network, these categories may also be pruned based on applications. That is, the decision tree is pruned lossless based on the categories implemented during the training of the neutral network.

If applicable, the data belonging to these pruned categories may be regarded as invalid.

With respect to the problem of classifying half-moons and analyze the decision tree produced by a neural network. We train a fully connected neural network with 3 layers with leaky-ReLU activations, except for last layer which has sigmoid activation. Each layer has 2 filters except for the last layer which has 1.

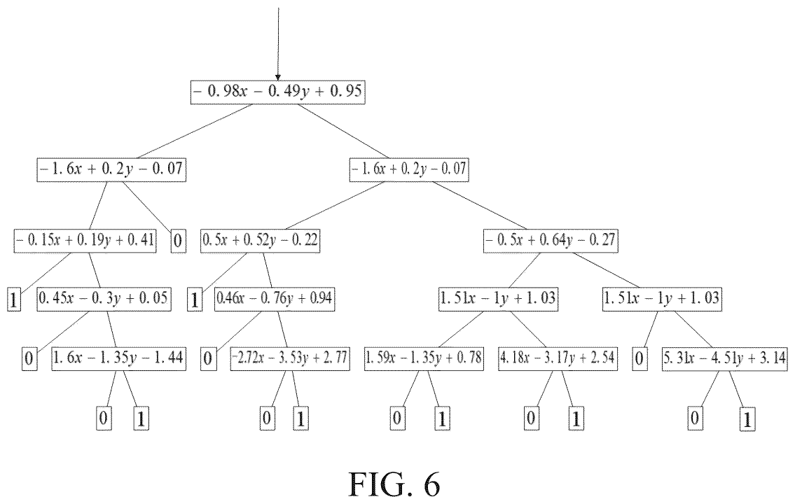

FIG. 6 is a schematic diagram of a decision tree according to another embodiment of the present disclosure. The decision tree in FIG. 6 is a category tree corresponding to a certain half-moon category neutral network.

As shown in FIG. 6, the decision tree finds many categories whose boundaries are determined by the rules in the tree, where each category is assigned a single class.

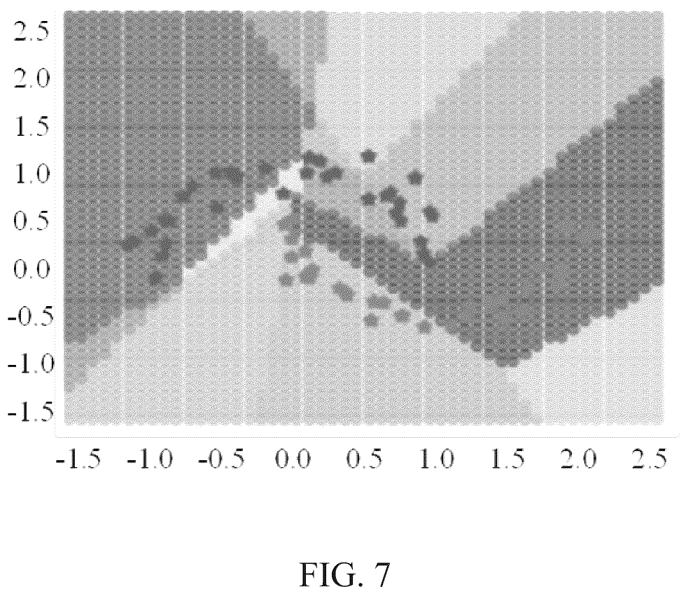

FIG. 7 is a schematic diagram of a decision tree according to another embodiment of the present disclosure.

In FIG. 7, different grayscales represent different categories. One can make several deductions from the decision tree such as some regions are very well-defined and the classifications they make are perfectly in line with the training data, thus making these regions very reliable. There are unbounded categories which help obtaining accurate classification boundaries, yet fail to provide a compact representation of the training data, these may correspond to inaccurate extrapolations made by neural decisions. There are also some categories that emerged although none of the training data falls to them

Based on the above, in the present disclosure, the neutral network is converted into decision tree, and is explained based on the decision tree, so as to solve the problem of black-box of the neutral network.

In an embodiment, based on the above conversion method of the neutral network, the present disclosure further provides a method for computing a neutral network.

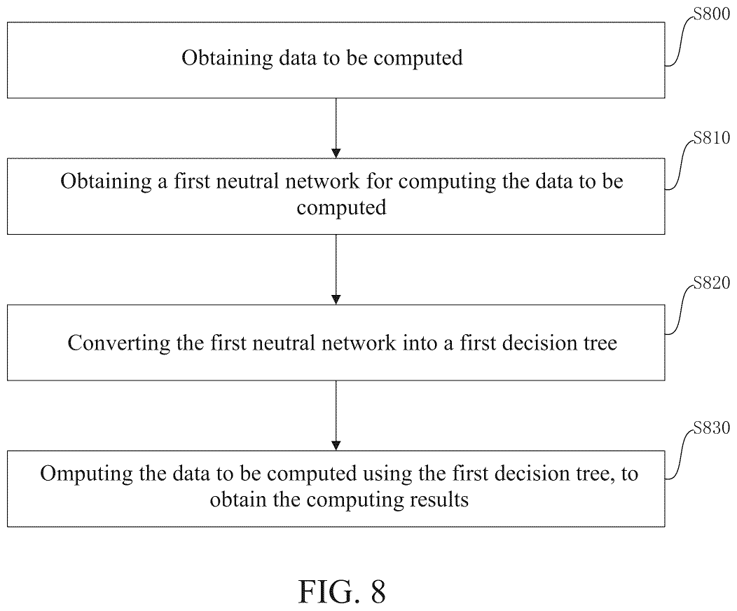

FIG. 8 is a schematic diagram of a process of computing a neutral network according to an embodiment of the present disclosure.

S800, obtaining data to be computed.

S810, obtaining a first neutral network for computing the data to be computed.

S820, converting the first neutral network into a first decision tree based on the method in the above embodiments.

S830, computing the data to be computed using the first decision tree, to obtain the computing results.

Compared to the neutral network, the decision tree provides certain computing advantages.

Table 1 shows computation and memory analysis of toy problems.

TABLE 1

| | y = x² | | | Half-Moon | | |
|---|---|---|---|---|---|---|
| | Param. | Comp. | Mult./Add. | Param. | Comp. | Mult./Add. |
| Tree | 14 | 2.6 | 2 | 39 | 4.1 | 8.2 |
| NN | 13 | 4 | 16 | 15 | 5 | 25 |

In Table 1, we compare the number of parameters, floatpoint comparisons and multiplication or addition operations of the neural network and the tree induced by it. As the induced tree is an unfolding of the neural network, it covers all possible routes and keeps all possible effective filters in memory. Thus, as expected, the number of parameters in the tree representation of a neural network is larger than that of the network. In the induced tree, in every layer i, a maximum of mi filters are applied directly on the input, whereas in the neural network always mi filters are applied on the previous feature, which is usually much larger than the input in the feature dimension. Thus, computation-wise, the tree representation is advantageous compared to the neural network one.

In embodiments of the present disclosure, the steps of the method flow can be implemented by functional division into various modules, and the division of each module is implemented in one or more software and/or hardware by a logical function division.

Apparatuses proposed in the embodiments of the present disclosure may be fully or partially integrated into a physical entity during actual implementation, or may be physically separated. And these modules can all be implemented in the form of software calling through processing elements. They can also all be implemented in hardware. Some modules can also be implemented in the form of software calling through processing elements, and some modules can be implemented in hardware. For example, the detection module may be a separately established processing element, or may be integrated in a certain chip of the electronic device. The implementation of other modules is similar. In addition, all or part of these modules can be integrated together, and can also be implemented independently. In the implementation process, each step of the above-mentioned method or each of the above-mentioned modules can be completed by an integrated logic circuit of hardware in the processor element or an instruction in the form of software.

For example, the above modules may be one or more integrated circuits configured to implement the above methods, such as: one or more specific integrated circuits (Application Specific Integrated Circuit, ASIC), or one or more digital signal processors (Digital Signal Processor, DSP), or, one or more Field Programmable Gate Array (Field Programmable Gate Array, FPGA) and so on. For another example, these modules can be integrated together and implemented in the form of an on-chip device (System-On-a-Chip, SOC).

In a practical application scenario, the method flow of the embodiments shown in the present disclosure may be implemented by an electronic chip installed on an electronic device. Therefore, an embodiment of the present disclosure proposes an electronic chip. For example, electronic chips are mounted on electronic equipment, and electronic chips include: at least one processor configured to execute the computer program instructions stored in a memory, when the computer program instructions are executed by the processor, the electronic chip is triggered to execute the method steps described in the above embodiments of the present disclosure.

An embodiment of the present disclosure further provides an electronic device.

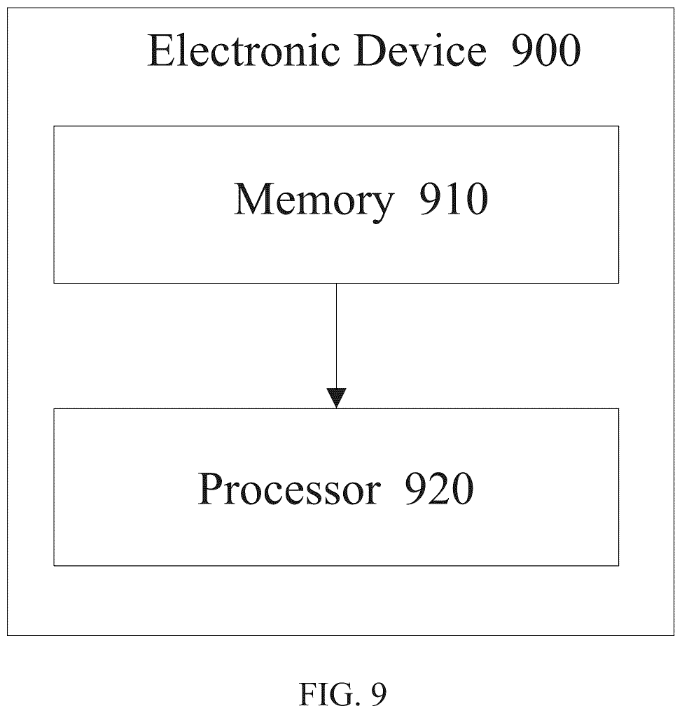

FIG. 9 is a block diagram of an electronic device according to an embodiment of the present disclosure.

The electronic device 900 includes a memory 910 for storing computer program instructions and a processor 920 for executing the program instructions, when the computer program instructions are executed by the processor, the electronic device is triggered to execute the method steps described in the above embodiments of the present disclosure.

In an embodiment of the present disclosure, the above-mentioned one or more computer programs are stored in the above-mentioned memory, and the above-mentioned one or more computer programs include instructions. When the above-mentioned instructions are executed by the above-mentioned device, the above-mentioned device is made to execute the method steps described in the above embodiments.

In an embodiment of the present disclosure, the processor of the electronic device may be an on-chip device SOC, and the processor may include a central processing unit (Central Processing Unit, CPU), and may further include other types of processors. In an embodiment of the present disclosure, the processor of the electronic device may be a PWM control chip.

In an embodiment of the present disclosure, the involved processor may include, for example, a CPU, a DSP, a microcontroller, or a digital signal processor, and may also include a GPU, an embedded Neural-network Process Units (NPU) and an image signal processor (Image Signal Processing, ISP). The processor may also include necessary hardware accelerators or logic processing hardware circuits, such as ASICs, or one or more integrated circuits for controlling the execution of the programs of the technical solution of the present disclosure Wait. Furthermore, the processor may have the function of operating one or more software programs, which may be stored in a storage medium.

In an embodiment of the present disclosure, the memory of the electronic device may be a read-only memory (ROM), other types of static storage devices that can store static information and instructions, random access memory (RAM) or other types of dynamic storage devices that can store information and instructions, also can be electrically erasable programmable read-only memory (EEPROM), compact disc read-only memory (CD-ROM) or other optical disc storage, optical disc storage (including compact disc, laser disc, optical disc, digital versatile disc, Blue-ray disc, etc.), magnetic disk storage medium or other magnetic storage device, or may also be capable of being used for portable or any computer-readable medium that stores desired program code in the form of instructions or data structures and can be accessed by a computer.

In an embodiment of the present disclosure, a processor may be combined with a memory to form a processing device, which is more commonly an independent component. The processor is used to execute program codes stored in the memory to implement the method described in the above embodiments of the present disclosure. During specific implementation, the memory can also be integrated in the processor, or be independent of the processor.

Further, the devices, devices, and modules described in the embodiments of the present disclosure may be specifically implemented by computer chips or entities, or by products with certain functions.

Those skilled in the art should understand that the embodiments of the present disclosure may be provided as a method, an apparatus, or a computer program product. Accordingly, the present disclosure may take the form of an entirely hardware embodiment, an entirely software embodiment, or an embodiment combining software and hardware. Furthermore, the present disclosure may take the form of a computer program product embodied on one or more computer-usable storage media having computer-usable program code embodied therein.

In the several embodiments provided in the present disclosure, if any function is implemented in the form of a software functional unit and sold or used as an independent product, it can be stored in a non-transitory storage medium. Based on this understanding, the technical solution of the present disclosure can be embodied in the form of a software product in essence, or the part that contributes to the related art or the part of the technical solution. The computer software product is stored in a storage medium including several instructions that are used to cause a computer device (which may be a personal computer, a server, or a network device, etc.) to execute all or part of the steps of the methods described in the various embodiments of the present disclosure.

An embodiment of the present disclosure further provides a non-transitory storage medium, where a computer program is stored in the non-transitory storage medium, and when it runs on a computer, the computer executes the method provided by the embodiments of the present disclosure.

An embodiment of the present disclosure further provides a computer program product, where the computer program product includes a computer program that, when running on a computer, causes the computer to execute the method provided by the embodiments of the present disclosure.

The descriptions of the embodiments in the present disclosure are described with reference to flowcharts and/or block diagrams of methods, apparatus (means), and computer program products according to the embodiments of the present disclosure. It will be understood that each flow and/or block in the flowcharts and/or block diagrams, and combinations of flows and/or blocks in the flowcharts and/or block diagrams, can be implemented by computer program instructions. These computer program instructions may be provided to the processor of a general purpose computer, special purpose computer, embedded processor or other programmable data processing device to produce a machine such that the instructions executed by the processor of the computer or other programmable data processing device produce Means for implementing the functions specified in one or more of the flowcharts and/or one or more blocks of the block diagrams.

These computer program instructions may also be stored in a computer-readable memory capable of directing a computer or other programmable data processing apparatus to function in a particular manner, such that the instructions stored in the computer-readable memory result in an article of manufacture comprising instruction means, the instruction apparatus implements the functions specified in a flow or flows of the flowcharts and/or a block or blocks of the block diagrams.

These computer program instructions can also be loaded on a computer or other programmable data processing device to cause a series of operational steps to be performed on the computer or other programmable device to produce a computer-implemented process such that the instructions provide steps for implementing the functions specified in one or more of the flowcharts and/or one or more blocks of the block diagrams.

It should also be noted that, in the embodiments of the present disclosure, “at least one” refers to one or more, and “multiple” refers to two or more. “And/or”, which describes the association relationship of the associated objects, means that there can be three kinds of relationships, for example, A and/or B, which can indicate the existence of A alone, the existence of A and B at the same time, and the existence of B alone. A and B can be singular or plural. The character “/” generally indicates that the associated objects are an “or” relationship. “At least one of the following” and similar expressions refer to any combination of these items, including any combination of single or plural items. For example, at least one of a, b, and c may represent: a, b, c, a and b, a and c, b and c, or a and b and c, where a, b, c may be single, or can be multiple.

In embodiments of the present disclosure, the terms “comprise”, “comprising” or any other variations thereof are intended to cover non-exclusive inclusion, so that a process, method, commodity or device including a series of elements not only includes those elements, but also includes other elements not expressly listed, or which are inherent to such a process, method, article of manufacture, or apparatus are also included. Without further limitation, an element qualified by the phrase “comprising a . . . ” does not preclude the presence of additional identical elements in the process, method, article of manufacture, or device that includes the element.

The application may be described in the general context of computer-executable instructions, such as program modules, being executed by a computer. Generally, program modules include routines, programs, objects, components, data structures, etc. that perform particular tasks or implement particular abstract data types. The application may also be practiced in distributed computing environments where tasks are performed by remote processing devices that are linked through a communication network. In a distributed computing environment, program modules may be located in both local and remote computer storage media including storage devices.

Each embodiment in the present disclosure is described in a progressive manner, and the same and similar parts between the various embodiments may be referred to each other, and each embodiment focuses on the differences from other embodiments. In particular, for the apparatus embodiments, since they are basically similar to the method embodiments, the description is relatively simple, and reference may be made to some descriptions of the method embodiments for related parts.

Those of ordinary skill in the art can realize that each unit and algorithm steps

described in the embodiments of the present disclosure can be implemented by a combination of electronic hardware, computer software and electronic hardware. Whether these functions are performed in hardware or software depends on the specific application and design constraints of the technical solution. Those skilled in the art may implement the described functionality using different methods for each particular application, but such implementations should not be considered beyond the scope of the present disclosure.

Those skilled in the art can clearly understand that, for the convenience and brevity of description, for the specific working process of the above-described devices, means and units, reference may be made to the corresponding processes in the foregoing method embodiments, which will not be repeated here.

The above descriptions are only specific implementations of the present disclosure. Any person skilled in the art can easily think of changes or substitutions within the technical scope disclosed in the present disclosure, which should be covered by the protection scope of the present disclosure. The protection scope of the present disclosure shall be subject to the protection scope of the claims.

What is claimed is:

1. A method for converting neural network, applied to a terminal device, comprising:
initializing a decision tree, and setting a root of the decision tree; and
branching leafs from the root of the decision tree based on effective filters of the neutral network as a decision rule, until all effective filters of the neutral network are covered by the decision tree, wherein the neutral network is a piece-wise linearly activated neutral network.

2. The method as described in claim 1, wherein the branching leafs from the root of the decision tree comprises:
starting from nodes branched from the root of the decision tree, further branching the nodes into leaf branches each corresponding to an effective filter, wherein an order of the effective filters is based on an order of the effective filters in a same layer of the neutral network and orders in different layers of the neutral network.

3. The method as described in claim 1, wherein, for a fully connected layer, an effective matrix is adopted as the decision rule.

4. The method as described in claim 1, wherein, for a skip connection layer, a residual effective matrix is adopted as the decision rule.

5. The method as described in claim 1, wherein, for a normalization layer, the normalization layer is embedded in a linear layer before or after pre-activation normalization or post-activation normalization, respectively.

6. The method as described in claim 1, wherein, for a convolution layer, an effective convolution is adopted as the decision rule.

7. The method as described in claim 1, further comprising:
lossless pruning the decision tree based on violating rules and/or redundant rules of the decision tree.

8. The method as described in claim 1, further comprising:
lossless pruning the decision tree based on categories realized during training of the neural network.

9. An electronic device, comprising:
a memory storing executable instructions; and
at least one processor coupled to the memory, wherein when executing the executable instructions, the at least one processor is configured to:
initialize a decision tree, and setting a root of the decision tree; and
branch leafs from the root of the decision tree based on effective filters of the neutral network as a decision rule, until all effective filters of the neutral network are covered by the decision tree, wherein the neutral network is a piece-wise linearly activated neutral network.

10. The electronic device as descried in claim 9, wherein the at least one processor is further configured to:
starting from nodes branched from the root of the decision tree, further branch the nodes into leaf branches each corresponding to an effective filter, wherein an order of the effective filters is based on an order of the effective filters in a same layer of the neutral network and orders in different layers of the neutral network.

11. The electronic device as descried in claim 9, wherein, for a fully connected layer, an effective matrix is adopted as the decision rule.

12. The electronic device as described in claim 9, wherein, for a skip connection layer, a residual effective matrix is adopted as the decision rule.

13. The electronic device as described in claim 9, wherein, for a normalization layer, the normalization layer is embedded in a linear layer before or after normalization that is subjected to activation or not subjected to activation, respectively.

14. The electronic device as described in claim 9, wherein, for a convolution layer, an effective convolution is adopted as the decision rule.

15. The electronic device as described in claim 9, wherein the at least one processor is further configured to:
lossless prune the decision tree based on violating rules and/or redundant rules of the decision tree.

16. The electronic device as described in claim 9, wherein the at least one processor is further configured to:
lossless prune the decision tree based on categories realized during training of the neural network.

17. A non-transitory storage medium storing computer executable instructions, wherein when the computer executable instructions are executed on a computer, the computer is triggered to:
initialize a decision tree, and setting a root of the decision tree; and
branch leafs from the root of the decision tree based on effective filters of the neutral network as a decision rule, until all effective filters of the neutral network are covered by the decision tree, wherein the neutral network is a piece-wise linearly activated neutral network.

18. The non-transitory storage medium as described in claim 17, wherein the computer is further configured to:
starting from nodes branched from the root of the decision tree, further branch the nodes into leaf branches each corresponding to an effective filter, wherein an order of the effective filters is based on an order of the effective filters in a same layer of the neutral network and orders in different layers of the neutral network.

19. The non-transitory storage medium as described in claim 17, wherein the computer is further configured to:
lossless prune the decision tree based on violating rules and/or redundant rules of the decision tree.

20. The non-transitory storage medium as described in claim 17, wherein the computer is further configured to:
lossless prune the decision tree based on categories realized during training of the neural network.
